(19) United States
(12) Patent Application Publication
(10) Pub. No.: US 2017/0297758 A1
(43) Pub. Date: Oct. 19, 2017

(54) HOLDING DEVICE FOR HOLDING BEVERAGE BOTTLES AND OTHER CONTAINERS DURING LABELING OF BEVERAGE BOTTLES AND OTHER CONTAINERS WITH A LABEL, OR DURING PRINTING OF BEVERAGE BOTTLES AND OTHER CONTAINERS

(71) Applicant: Holger STENNER, Haltern am See (DE)

(72) Inventor: Holger STENNER, Haltern am See (DE)

(21) Appl. No.: 15/429,425

(22) Filed: Feb. 10, 2017

Related U.S. Application Data
(63) Continuation-in-part of application No. PCT/EP2015/065022, filed on Jul. 1, 2015.

(30) Foreign Application Priority Data
Aug. 12, 2014 (DE) 10 2014 111 493.0

(51) Int. Cl. B65C 9/02; B65C 3/26

(52) U.S. Cl. CPC B65C 9/02; B65C 3/26

(57) ABSTRACT

Holding device for holding beverage bottles and other containers during labeling of beverage bottles and other containers with a label, or during printing of beverage bottles and other containers. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2015/065022, filed on Jul. 1, 2015, which claims priority from Federal Republic of Germany Patent Application No. 10 2014 111 493.0, filed on Aug. 12, 2014. International Patent Application No. PCT/EP2015/065022 was pending as of the filing date of this application. The United States was an elected state in International Patent Application No. PCT/EP2015/065022.

### BACKGROUND

### 1. Technical Field

The present application relates to a holding device for holding beverage bottles and other containers during labeling of beverage bottles and other containers with a label, or during printing of beverage bottles and other containers.

### 2. Background Information

Background information is for informational purposes only and does not necessarily admit that subsequently mentioned information and publications are prior art.

The present application relates to a holding and centering device for containers, for example for liquid containers such as bottles, beakers, glasses, and the like.

Containers such as beverage bottles made of glass or plastic run through different work stations in a container treatment system. For processing in the individual work stations, the containers are clamped or held and positioned in a predetermined position in order, for example, to be inspected, labeled, printed, or other working stages in an exact or essentially exact or general manner. Such exact or precise positioning can be very important in such bottle or container treatment or handling procedures in order to promote accuracy and precision of the printed image, the label, or the inspection.

In some holding devices for beverage bottles, gripping arms are used to secure the beverage bottles at the neck of the bottle. For some holding devices, a beverage bottle is positioned between a gripper arm, which is positioned on or at a flange at the neck of the bottle, and is clamped by a centering tulip or centering structure which is introduced into the opening of the container. The centering structure can be essentially cylindrical with a slightly curved, tapered end that can be inserted at least partially into a container mouth or opening.

With some holding devices, a precise centering of the container in the holding device is difficult. In addition to this, such holding devices can in each case only be used for one or a small number of different types of containers, such that, if the container is changed, the holding device in the container handling system must also be replaced.

### OBJECT OR OBJECTS

The present application is therefore based on an object of providing an improved holding device which can be used for a plurality of different types of containers having different structural designs and/or dimensions.

### SUMMARY

The present application solves this object by a holding and centering device with the features disclosed in the present application. Further exemplifications of the present application are disclosed in the present application. In this context, the features described are in principle objects of the present application, alone or in any desired combination.

The holding and centering device of the present application for containers comprises a centering head with a cut-out recess or opening into which a container can be introduced. The holding and centering device also comprises a clamping device arranged at the centering head for clamping the containers. The clamping device comprises at least three clamping elements arranged around the recess. The clamping elements are mounted in movable manner, such that the clamping elements can be moved, such as in a radial direction, between a clamping position and a release position. In the clamping position, the clamping elements are extended symmetrically into the recess, and, in the release position, the clamping elements are retracted.

The holding and centering device is configured to be a universal holding device, in which a plurality of different containers or different types of containers can be clamped or held. One feature of the holding and centering device according to the present application is that it clamps any container which is introduced into the recess, regardless of its size and/or its diameter, in a central position, i.e., centered to the device. The device may therefore be limited by the size of the recess, i.e., the device can accommodate and clamp centrally any container that can be introduced into the recess, at least in sections. Due to the automatic centering, any further alignment of the containers is very largely unnecessary or undesired.

The automatic centering takes place by means of a uniform take-up of the container from at least three sides by the clamping device. That is to say, in the central position, the clamping elements are in contact with the container in the circumferential direction at a uniform or essentially uniform distance interval from one another, and a longitudinal axis of the container is arranged congruent or coaxial with respect to a mid-axis of the recess.

The clamping device can be arranged as a separate component on the outside at the centering head, as a result of which it is in one possible exemplification easy to access. The clamping device, in one possible exemplification, can also be configured as an integral component of the centering head. In at least one possible exemplification, the clamping device and centering head can be a common holding and centering puck or puck-shaped device, which is mounted such as to rotate and be driven about a vertical axis at least with the part which carries the clamping device and centering head.

The clamping elements advantageously carry out a synchronous or substantially synchronous movement between the release position and clamping position, wherein “synchronous” or “substantially synchronous” are understood to mean that the clamping elements extend in the radial direction into the recess and/or clear the recess at the same speed. In this situation, the clamping elements are configured in such a way that, in the clamping position, they are in contact with the container at a uniform distance interval from each other, such that the container is automatically guided into the central position.

The clamping elements are arranged around the recess, i.e., in the circumferential direction around it. In this situation, the clamping elements are, in one possible exemplification, arranged at a uniform distance interval from one another, for example symmetrically or substantially symmetrically.

The shape of the clamping elements can in this situation be configured at will, wherein, however, they are in one possible exemplification designed as flat or substantially flat structures. The clamping elements can be configured as corresponding to one another, such that, in the closed position, they form a positive fit closure, in which they are in contact with one another with one or more side edges, and, if appropriate, form together a closed or at least partially closed plane. In one possible exemplification of the present application, for this purpose the clamping elements comprise outer edges which are configured to correspond to one another and are aligned pointing inwards, which are, for example, curved in shape. In other words, the sides of the clamping elements follow or match, or substantially follow or match, the sides of their adjacent clamping elements. In this manner, when the clamping elements are in the clamping position, the sides of the clamping elements may be in contact with one another to close any space between adjacent clamping elements, and thereby form a continuous flat surface. In another possible embodiment, when the clamping elements are in the clamping position, the sides of the clamping elements may be near one another to close most space between adjacent clamping elements, and thereby form a flat surface with small gaps therein. As an alternative, the clamping elements can form a central closure. In that situation, they are configured in lamellar or layered fashion, and arranged in the form of an iris diaphragm, at least partially overlapping, such that, at the radial movement, they slide in sections over one another.

The radial direction extends between an outer edge of the centering head and the mid-axis of the recess. The movement of the clamping element can take place in different manners in this situation. For example, the clamping elements can be moved forwards and backwards by means of a straight movement. The clamping elements can also be moved, for example, by a rotational movement in the radial direction, such that at least parts of the clamping element run through a bow-shaped or curved or arc-shaped trajectory.

In the release position, the clamping elements have adopted a position in which the container can be introduced into the recess. The release position can, in one possible exemplification, be a position in which the clamping elements do not close the recess, or in sections. In the clamping position, by contrast, the clamping elements are extended out of the release position into the recess so far that they are in contact with the container and, for example, exert a pressure clamping effect on the container. As an alternative, the clamping elements can also adopt a closed position, in which they are extended so far that they close the recess entirely or almost entirely. The clamping elements can be configured so as to be extendible and/or retractable steplessly.

The recess is configured, in one possible exemplification, as a hole in the centering head, and in one possible exemplification exhibits a circular cross-section. The recess is configured in this situation in such a way that different sizes of containers, such as containers with different diameters, can be introduced into the recess, or even moved through the recess. In any event, the container is, at least in sections, configured such that it can be moved with a neck or opening region, for example with a bottle neck, through the recess. To this extent, the term “introduced into the recess” is also understood to mean the movement of individual bottle sections, at least section by section, into and/or through the recess.

The centering head is configured as disk-shaped or ring-shaped, and comprises a central, i.e. middle recess, which is configured, for example, in the form of a ring hole. The centering head accordingly forms a plane. The recess and the clamping device are in one possible exemplification arranged in such a way that the container can be introduced in a direction transverse to the plane (perpendicular or substantially perpendicular) of the centering head, and is clamped by means of a movement of the clamping elements transverse to the direction of introduction.

The recess is therefore configured in such a way, for example, that a standardized beverage bottle can be introduced with its bottle neck through the recess and can be gripped by the holding device such that the bottle is centered. The centering head is therefore also configured, for example, such that it can be located onto a bottle neck, such that, in an operating position, the centering head is arranged around the bottle neck, and the clamping elements are in contact with the bottle neck and clamp it.

The term “containers” is understood to mean, in one possible exemplification, packing means for filling drinking liquids. Accordingly, containers are understood to be, in one possible exemplification, beverage cans and beverage bottles, for example of glass, plastic, or metal. The holding device is, in one possible exemplification, well-suited for containers which comprise a round cross-section at least in the region at which the clamping elements engage, or at least the cross-section of a regular rectangle, such that the centering can take place easily.

With a container which exhibits a regularly shaped cross-section in the engagement region of the holding device, such as a round cross-section or a cross-section in the form of a regular rectangle, in the central position the mid-axis of the container and the mid-axis of the recess are arranged congruently on one another.

The holding device can be located in different work stations of a container treatment system. In one possible exemplification, the holding device is well-suited for use in a labeling device or in a work station for printing the containers. The holding device can also be located, for example, in an inspection device or filling station.

For a uniform centering of the container between the clamping elements, at least three clamping elements may be utilized. In this situation, each clamping element in the clamping position forms a contact point with the container. In order to improve or substantially improve the centering and to achieve a larger contact surface or more contact points for the clamping device on the container, at least four, five, or more clamping elements could be utilized. The more clamping elements are arranged, the more contact points are present between the clamping device and the container.

Regardless of the number of clamping elements, in the clamping position they grip the container symmetrically, being arranged, for example, symmetrically or substantially symmetrically around the recess, and, in one possible exemplification, are moved in relation to one another in such a way that they move in synchrony or substantially synchronously in the radial direction between the release position and the clamping position or closure position.

For a possibly stable exemplification of the centering head, this comprises at least two housing elements arranged parallel or substantially parallel to one another, wherein the recess extends through both housing elements, and the clamping elements are arranged between the housing elements. The housing elements are in one possible exemplification configured as flat and can be disk-shaped or ring-shaped, corresponding to the centering head, wherein, for example, the ring hole forms the recess.

The housing elements can be located at a distance from one another, in order, for example, for the clamping elements to be arranged between the housing elements. Depending on the exemplification arrangement, the clamping elements are arranged between the housing elements next to one another and parallel or substantially parallel (positive fit closure) to the two housing elements, or, alternatively, arranged so as to overlap in sections (central closure), and form a plane which is aligned parallel or substantially parallel to the housing elements.

As already indicated, the clamping elements can be moved by means of different movement sequences to and fro between the release position and into the clamping position. As well as a straight trajectory, a curved trajectory of the clamping elements is possible. For this purpose, provision is made according to a further exemplification of the present application for each clamping element to be mounted so as to rotate about a rotation axle arranged in the longitudinal axial direction.

The longitudinal axial direction can correspond to the insertion direction of the container, and, in one possible exemplification, is aligned perpendicular or substantially perpendicular to the plane of the centering head (of the housing elements). The rotation axles can be configured, for example, as rotation bolts, which in each case are connected to a clamping element. The rotation axles are mounted on the clamping elements, for example, eccentrically, as a result of which, during a rotational movement, the curved trajectory of the clamping elements takes place between the release position, in which they are, for example, covered by the housing elements completely or very nearly completely, and the clamping position, in which they cover the recess at least in sections. In addition, the clamping elements can also be configured, for example, in such a way that they completely close the recess in a closed position.

In order to be able to move the clamping elements between the release position and the clamping position, or closed position as appropriate, a corresponding drive device can be arranged which takes effect on the clamping elements.

As an alternative, the movement of the clamping elements can also be produced by a movement of the housing elements, such that the clamping elements are not driven directly, but rather a housing element drive is arranged, by means of which the clamping element movement is carried out. For this purpose the clamping elements are coupled to at least one of the housing elements. For at least one possible exemplification, the housing elements are arranged such as to rotate against one another, wherein the clamping elements are moved, due to the rotational movement, between the release position and the clamping position.

In one possible exemplification, the housing elements are arranged in relation to one another and coupled to the clamping element in such a way that, due to the rotational movement of the housing elements against one another about the mid-axis of the recess, the radial movement of the clamping elements takes place. “Rotatable against one another” means in this context that one of the housing elements can be rotated to the right and the other housing element to the left about the axis of rotation (for example, the mid-axis of the recess). As an alternative, one of the housing elements is configured as rigid, and the other housing element is mounted on the rigid housing element such as to be rotatable right and/or left about the axis of rotation.

The coupling between the housing elements and the clamping device can therefore be configured in such a way that, due to the rotational movement of at least one of the housing elements, the clamping elements are moved out of the release position into the clamping position or the closed position respectively, and, at the movement of the housing element in the opposite direction, i.e. with a counter-directional movement, the clamping elements are retracted from the closed/clamping position into the release position again.

The coupling of the clamping device or the clamping elements respectively to the housing elements takes place in one possible exemplification by way of the rotation axle of the clamping elements, such that, according to a further exemplification of the present application, the rotation axles are mounted with a first end in a fixed position in one of the housing elements, and with a second end movably mounted in the other housing element.

The term “fixed position” is understood in this context to mean that the rotation axle is rotatably mounted, as appropriate, in the housing element, but its relative position in relation to the housing element is not changeable. The rotation axle is arranged in a section, such as a side flank or an end region, in the housing element. In the other housing element, i.e. in the housing element in which the rotation axle is not mounted in a fixed position, the rotation axle is movably mounted. For this purpose, for example, a thrust device is arranged, in which the rotation axle is mounted. The thrust device can be configured as a link guide, in which the rotation axle is mounted such as to be capable of being thrust forwards and backwards. The rotation axle can also be mounted in the thrust guide by means of a rotation ring. The thrust guide can run in a curved manner, and can be adjusted, for example, to the radius of the housing elements. Each thrust guide can therefore be configured as a section of a circular arc, and arranged about the recess. Corresponding to the fixed-position mounting, the rotation axle can additionally be rotatably mounted in the region of the thrust guide.

For at least one possible exemplification, the clamping device comprises at each clamping element a guide unit, with a link bolt arranged at the clamping element, this bolt being mounted with a first section in a link guide of the first housing element. In at least one possible exemplification, in an operational position, the first housing element is the lower housing element. The link guides can be arranged in the circumferential direction around the recess, at uniform distance intervals, for example symmetrically, from one another in the housing element. In this situation, the link guides, and their longitudinal axes, can be configured as straight and can be arranged obliquely to the radius.

Each link bolt is mounted in the respective clamping element in a fixed position or is rotatable as appropriate, and arranged in such a way that, at the rotational movement of the housing elements in relation to one another, the link bolt is moved forwards and backwards in the link guide. The link guides with link bolts are arranged in such a way that, due to the rotational movement of the housing element, the clamping elements move out into the recess or retract back into the release position, i.e. they undergo, for example, a rotational movement about the respective rotation axle.

For a possibly secure guidance of the clamping element, and in order, for example, also to essentially ensure or promote a play-free guiding, provision is made according to a further exemplification of the present application, for the link bolt to be guided with a second section, opposite the first section, in a link guide of the second housing element. The second housing element is in this situation, in the operating position, in one possible exemplification the upper housing element.

The link guide of the second housing element is, in one possible exemplification, configured in sections as curved, and, for example, likewise extends obliquely to the radius. Due to the straight and curved course of the two link guides, an unintentional movement of the housing elements in relation to one another is prevented, restricted and/or minimized, due to vibrations when in operation, for example.

In an alternative exemplification, the actuation takes place due to effect imposed onto the ends of one or more clamping elements, located radially outwards and projecting out of the housing elements. The effect is imposed in this situation radially inwards, i.e. perpendicular or substantially perpendicular to the mid-axis.

An important factor in this situation is that one of the housing elements is connected securely to the respective reception part, for example a holding and centering puck, in respect to the relative position, and the other housing element is freely movable about a vertical axis. The pivoting or thrust movement of one or more clamping elements provides for the rotational movement of the freely-movable housing element, and therefore also for a movement of the other clamping elements.

For one possible operation of the holding device, in one possible exemplification a spring is arranged, which creates a pre-tension between the link bolt and a bearing element arranged at the housing. The bearing bolt is in this situation connected securely to the centering head or, respectively, to one of the housing elements. The spring can be configured in such a way that, due to the connection of the guide bolt to the clamping element, a pressure tension is imposed on the clamping element, due to which the clamping element is held in the release position. In at least one possible exemplification, however, the spring is configured as a tension spring, such that the clamping elements, due to the drawing tension of the spring onto the link bolt, are held in an extended state, for example in the clamped position or the closed position if appropriate. By means of the spring, therefore, the strength of the pressure tension on the clamped container can be controlled.

In one possible exemplification with the use of the holding device with plastic bottles, such as blow-molded PET bottles, which in part are extremely thin-walled, the problem arises that the bottles give or slightly collapse inwardly during printing or labeling. In order to essentially ensure or promote a stable shape of the beverage bottle in this situation, provision is made according to a further exemplification of the present application that a closure unit is arranged, which closes a container opening. The closure unit prevents, restricts and/or minimizes the forced emergence of the medium present in the container, such as gas or air, as a result of which the shape stability of the container outer wall is essentially ensured or promoted. The closure unit is therefore configured in one possible exemplification so as to close the container opening gas-tight.

In at least one possible exemplification, the closure unit is additionally configured so as to introduce a medium into the container. As a result, it is possible for the container opening to be closed and, for example, a gas to be introduced into the container, in order to create an overpressure in the container. Due to the overpressure, the outer wall of the container achieves, in one possible exemplification, a high shape stability, such that the further treatment of the outer wall of the container, such as labeling or printing of the wall is relatively simple.

According to one possible exemplification, a rotary information-adding machine is used to apply information, in the form of labels or printing, to containers, such as blow-molded PET beverage bottles. A plurality of holding devices are disposed about the periphery of a rotor or carousel. Each holding device is designed to hold one bottle. Such beverage bottles are usually held in a suspended manner at a neck area of the bottle by placing a support structure under an annular flange that projects from the neck area. In this manner the body of the bottle, which is below the neck of the bottle, is free to be labeled or printed. In many such machines, the holding structure is in the form of a bracket with a U-shaped or C-shaped recess therein. To hold a PET beverage bottle, the neck of the bottle below the annular flange is inserted into the recess, while the annular flange rests on top of the bracket in the areas about the recess. Often times, the recess is designed to closely match or follow the dimensions of each bottle to be held. For example, the diameter of the recess in each holding device will be about equivalent to the diameter of the neck of each bottle. As a result, the holding device is not designed to hold bottles with different dimensions, such as, for example, bottle necks of different diameters or shapes that do not fit into or match the recess. The holding device according to one exemplification of the present application overcomes this obstacle by using an adjustable holding structure that adjusts to each bottle, such as bottles of different diameters.

The holding structure, according to one exemplification, is a ring-shaped structure with a hole or opening therein. The holding structure is substantially flat and can be designed as basically two rings, layered one on top of the other. In between the two rings are located movable, flat holding elements. The holding elements can be of a number of different shapes, or have a profile that substantially or approximately follows a number of different shapes, such as, but not limited to, teardrop shapes, pie-piece shapes, triangles, curved triangles, cones, and truncated cones. The holding elements are maintained in a retracted position between the two rings to keep the hole in the rings completely open. In operation, a bottle is inserted mouth-first into the opening until the annular flange projecting out from the neck of the bottle is above or past the holding elements. At this point the holding elements are moved out of their retracted position and toward the bottle neck until they contact the bottle neck. Since movement of the holding elements is stopped by the bottle neck, the holding structure is adjustable for bottle necks of different diameters. Therefore, essentially any bottle can be held so long as the bottle mouth and the annular flange can fit through the hole. Once the holding elements are moved into contact with the bottle neck, the holding elements can hold the bottle by gripping the bottle neck and/or by supporting the bottle from below via the annular flange.

There are a number of ways to cause the movement of the holding elements, as discussed herein. Drive devices can be included to directly move the holding elements back and forth. Another option is to design the two rings to be rotatable relative to one another, and to include a mechanical linkage arrangement such that, when one or both of the two rings is or are rotated, the holding elements are moved back and forth. Of the two rings, one can be stationary or fixed in position, while the other is rotatable with respect to the stationary ring. Alternatively, both of the rings could be movable or rotatable. Any rotatable ring can be operatively or directly connected to a drive or other mechanism that generates the rotational movement of the ring. Any stationary ring can be connected to a stationary object or mount that keeps the stationary ring in a fixed position.

In one possible embodiment, the holding structure holds empty plastic or PET bottles in an information-adding machine, such as a printer or labeler. Since a PET bottle usually has a relatively thin side wall about the body of the bottle, the side wall has a tendency to give or collapse inwardly when pressed by a printing unit or a labeling unit during printing or labeling. Such “give” can result in inaccurate application of labels and misprinting. To reinforce the bottle, a gas-delivery mechanism is brought into a sealed engagement with the mouth of the bottle. Gas is then introduced into the bottle to pressurize the interior thereof, which in turn prevents or minimizes the give or slight collapse of the side wall. In some embodiments, an external sleeve is used which surrounds the gas-delivery mechanism to protect it against contamination by dirt or other such contaminants. When the holding structure is fully closed, or partially closed around a bottle, the holding structure fully closes or partially closes the open end of the external sleeve, to essentially enclose the gas-delivery mechanism for even greater protection against contamination.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is described in greater detail hereinafter on the basis of a number of exemplary exemplifications. The figures show:

FIGS. 1A-1C in a perspective view, a schematic representation of a first exemplification of the holding device, with clamping elements in different positions;

FIG. 1D in a perspective view, a schematic representation of the holding device from FIGS. 1A-1C, with a centering tulip and clamping elements in a release position;

FIG. 1E represented schematically in cross-section, the holding device with the centering tulip from FIG. 1D, with a container fixed in a central position;

FIG. 2A represented in a perspective view and schematically, a further exemplification of the holding device with clamping elements in the closed position;

FIG. 2B a schematically represented view of the underside of the holding device from FIG. 2A;

FIG. 2C the exemplification of the holding device from FIGS. 2A and 2B in a representational view from above, with a beverage bottle fixed in a central position;

FIG. 2D represented in a perspective and schematic view the holding device from FIG. 2C from the underside;

FIG. 3 shows a block diagram of a possible exemplification of the holding device.

### DESCRIPTION OF EXEMPLIFICATION OR EXEMPLIFICATIONS

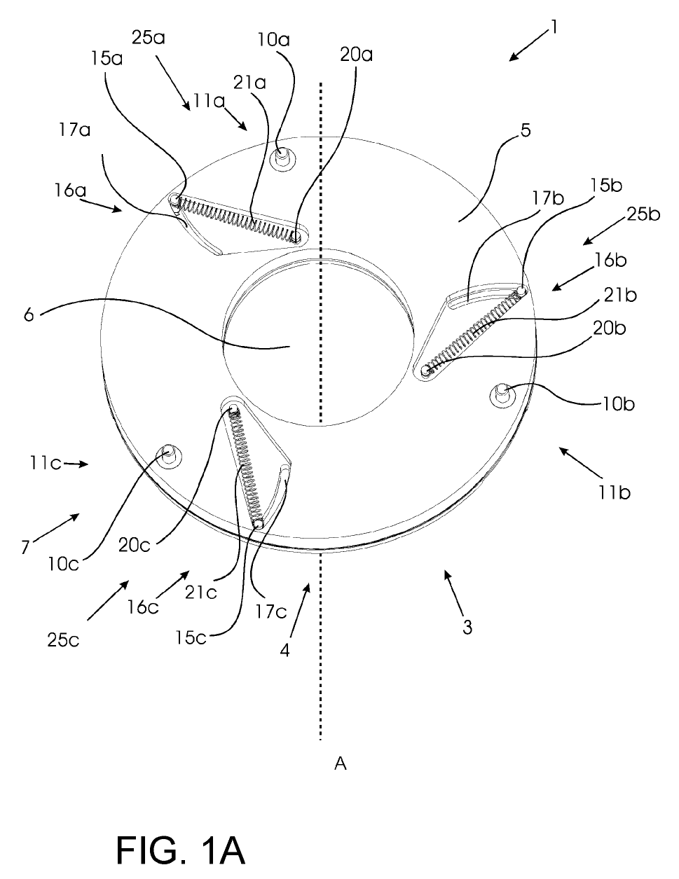

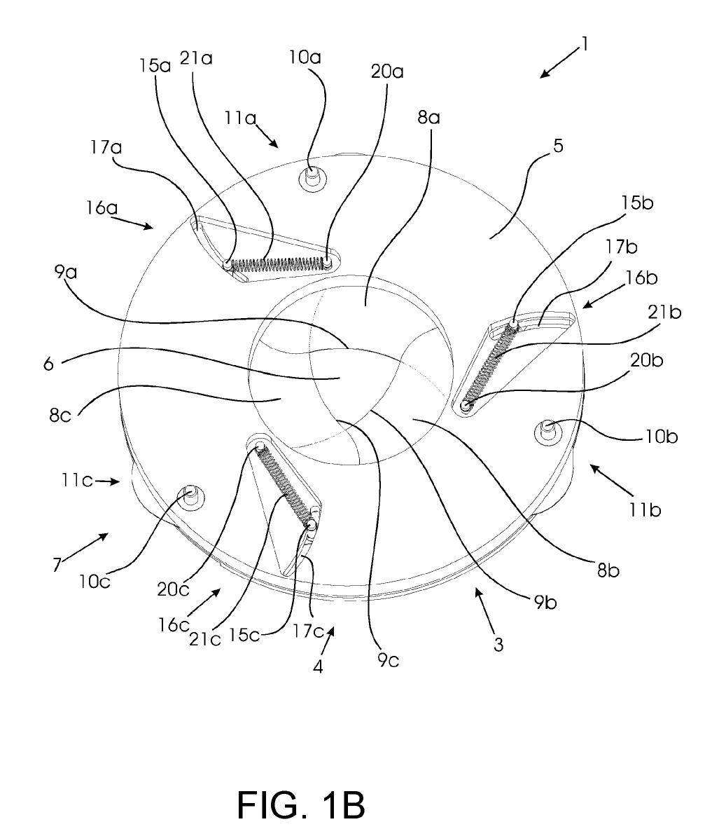

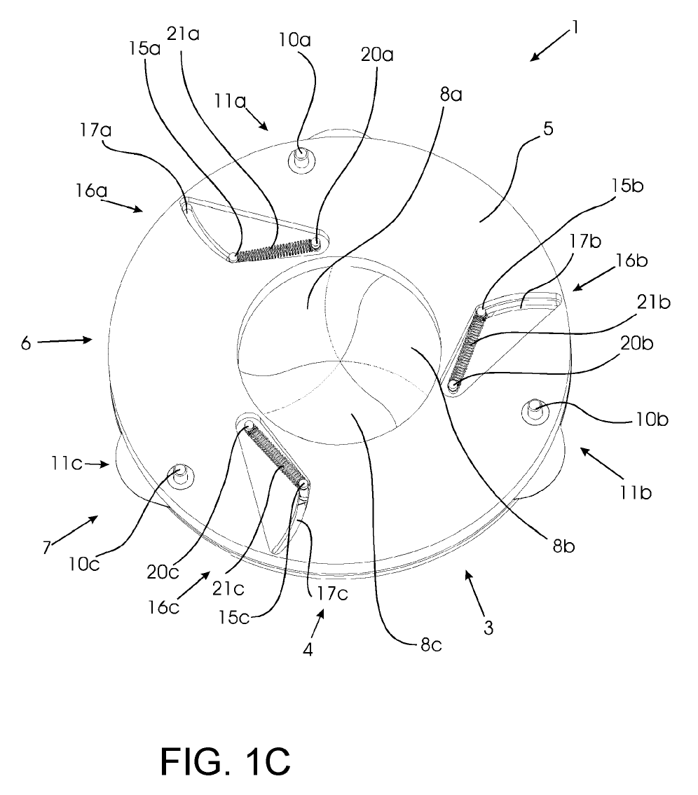

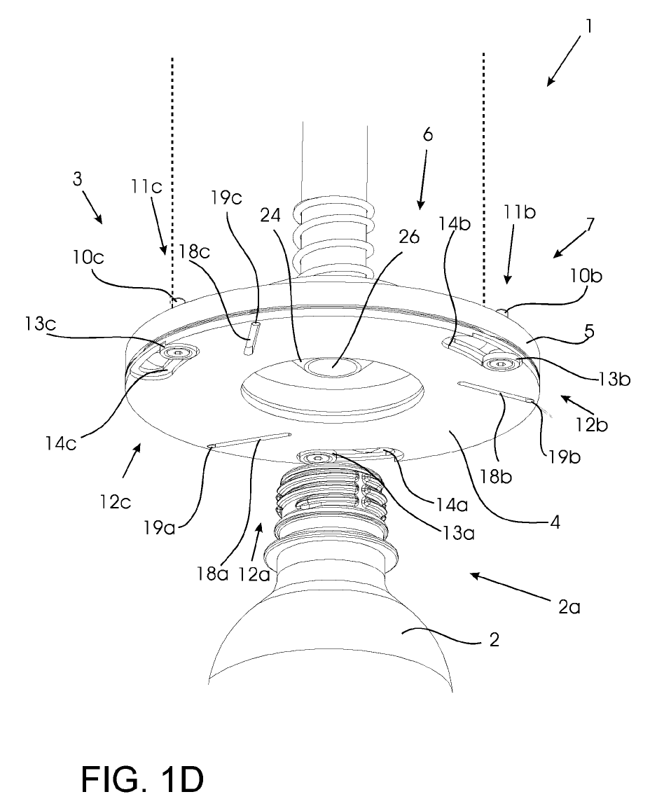

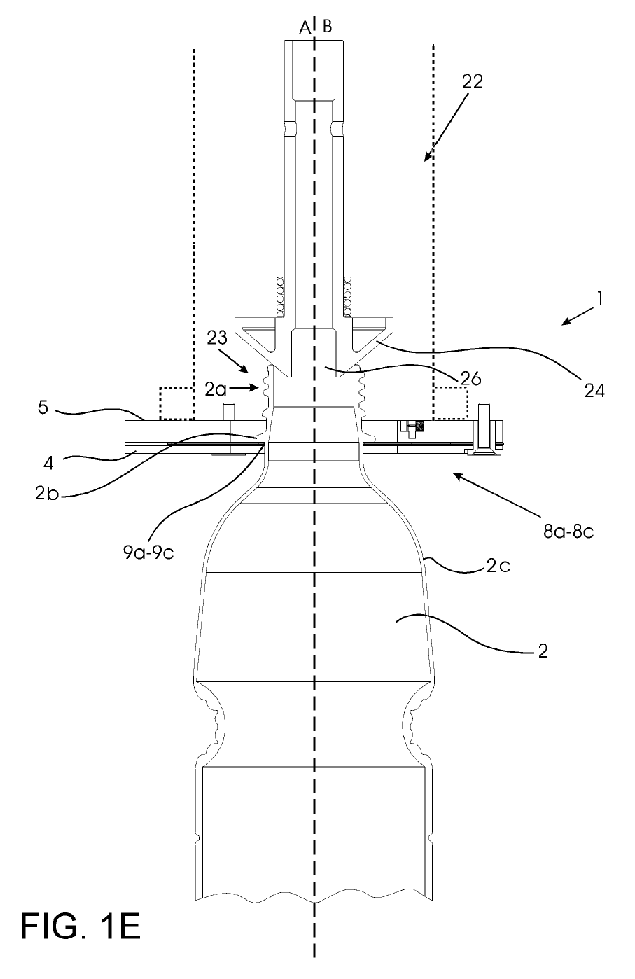

FIGS. 1A-1C show a first exemplification of a holding device 1 for the clamping of containers 2 (see FIG. 1D). The holding device 1 comprises a centering head 3 with a first and a second housing element 4, 5. The two housing elements 4, 5 are arranged parallel or substantially parallel to one another, configured as flat, and exhibit a ring-shaped form. Arranged in the middle in both housing elements 4, 5 is a central ring hole. The ring holes form the recess 6 for introducing the container 2. The holding device 1 is configured in such a way that the container 2 can be introduced into the recess 6 perpendicular or substantially perpendicular to the plane of the housing elements 4, 5, in the direction of the mid-axis A.

Arranged between the housing elements 4, 5 is a clamping device 7 with three clamping elements 8a-8c. As an alternative, it is also possible for more than three clamping elements 8a-8c to be arranged, such as four, five, or six clamping elements 8a-8c. The clamping elements 8a-8c are arranged symmetrically or substantially symmetrically around the recess 6. Each clamping element 8a-8c is configured as flat and comprises a contact surface 9a-9c, which is provided for contact with the container 2 introduced into the recess 6 (see FIG. 1E).

Each clamping element 8a-8c is rotatably mounted about a rotation axle 10a-10c, and can be moved from a release position (FIG. 1A), in which the clamping elements 8a-8c are retracted, into a clamping position (FIG. 1B), in which the clamping elements 8a-8c are extended symmetrically in the radial direction into the recess 6, and, if appropriate, as far as into a locked position (FIG. 1C) in which the clamping elements 8a-8c close the recess 6.

During the movement between the release position and the clamping/closed position, each clamping element 8a-8c runs through a curved trajectory. In the closed position, the clamping elements 8a-8c jointly close the recess 6.

The rotation axles 10a-10c are configured as rotation bolts, and are arranged in a longitudinal axial direction. That is to say, the rotation bolts 10a-10c stand perpendicular or substantially perpendicular on the plane of the housing elements 4, 5, and are arranged parallel or substantially parallel to the mid-axis A. Each rotation axle 10a-10c is arranged in a fixed position and eccentric to a clamping element 8a-8c.

In addition to this, each rotation bolt 10a-10c is mounted with a first end 11a-11c in a fixed position and rotatably in the second housing element 5. Its relative position to the second housing element 5 is not changeable.

By way of a second end 12a-12c (FIG. 1D), located opposite the first end 11a-11c, the rotation axles 10a-10c are mounted such as to be displaceable at the first housing element 4. For this purpose, a bearing ring 13a-13c is arranged in each case at the second end 12a-12c of the rotation axles 10a-10c, this ring being mounted in a thrust guide 14a-14c located in the first housing element 4.

The thrust guide 14a-14c is configured as curved and adapted to the radius of the housing elements 4, 5. The first and second housing elements 4, 5 are therefore arranged at a distance interval from one another, and connected to one another by way of the rotation axles 10a, 10c. The thrust guide 14a-14c allows for a rotational movement of the two housing elements 4, 5 against one another.

Each clamping element 8a-8c is coupled by way of a guide device 25a-25c to the housing elements 4, 5, as a result of which the clamping elements 8a-8c can be extended and retracted respectively by means of the rotational movement. The guide devices 25a-25c are identical.

Each guide device 25a-25c comprises link bolts 15a-15c mounted in a link guide 17a-17c. The link bolts 15a-15c are in each case mounted fixed in position, but if applicable also rotatable about a longitudinal axis at a clamping element 8a-8c. The longitudinal axis of the link bolts 15a-15c is aligned parallel or substantially parallel to the mid-axis A. The link bolts 15a-15c are mounted with a first section 16a-16c in each case in a link guide 17a-17c, arranged in the upper (second) housing element 5, this guide being configured as curved, and with a second section 19a-19c, opposite the first section 16a-16c, in a link guide 18a-18c, arranged in the lower (first) housing element 4 and configured as straight. Both link guides 17a-17c, 18a-18c are arranged obliquely to the radial direction.

In addition, a pre-tension is imposed at the clamping elements 8a-8c. For this purpose, in each case a spring 21a-21c is arranged at the first section 16a-16c of the link bolt 15a-15c, this spring being connected to a bearing element 20a-20c at the upper housing element 5. The springs 21a-21c are configured as tension springs, such that the clamping elements 8a-8c are held in the closed position (FIG. 1C) by the spring force taking effect. That is to say, a pre-tension is imposed at the clamping elements 8a-8c, which holds the clamping elements 8a-8c in the closed position (FIG. 1C).

In order to move the clamping elements 8a-8c out of the closed position into the release position (position 1a), the link guides 17a-17c in the upper housing element 5 and the link guides 18a-18c in the lower housing element 4 are matched to one another in such a way that, with a rotational movement of the housing elements 4, 5 against one another, the guide bolts 15a-15c are moved in the link guides 17a-17c, 18a-18c, wherein the clamping elements 8a-8c connected to the link bolts 15a-15c rotate outwards about the rotation axles 10a-10c, i.e. they are retracted, and clear the recess 6.

Due to the fact that the clamping elements 8a-8c are arranged in the circumferential direction of the housing elements 4, 5 at a uniform spacing interval from one another, the movement of the clamping elements 8a-8c out of the release position into the clamping position or closed position respectively, and the reverse movement also takes place uniformly (synchronously), such that, when a container 2 is clamped between the contact surfaces 9a-9c, a centering of the container 2 in the holding device 1 takes place automatically.

FIGS. 1D and 1E additionally show a closure unit 22 for the gas-tight closure of a container opening 23. The closure unit 22 comprises a centering tulip or centering unit 24 and an inner channel with a gas outlet opening 26. The cross-sectional profile of the centering tulip or centering unit 24, as can be seen in FIG. 1E, is substantially in the shape of a dome or truncated cone. In this situation, the centering head 3 with the two housing elements 4, 5, and the other elements referred to heretofore, as well as the closure unit 22 with the associated centering tulip 24, are parts of a common module, which is configured in the form of a holding and centering puck. This is indicated by walls presented as broken lines. The term “puck” can describe the approximate external shape of all of the components together, as they form a somewhat thick, substantially cylindrical or disc-shaped or puck-shaped structure, like an ice hockey puck. The housing element 5 is in this situation secured in a fixed position at the holding and centering puck outlined by broken lines, wherein the first housing element 4, as described above, is rotatably mounted at the second housing element 5 and interacts with it. The centering tulip 24 or, respectively, the supporting tube section, is mounted in the holding and centering puck so as to be axially displaceable. The holding and centering puck comprises two components, not represented in detail, of which the component carrying the housing element 5 is mounted such as to rotate about a vertical axis. In this situation, the rotatable component can in one possible exemplification be driven by a motor, or can also be the rotor of an electromagnetic direct drive.

One advantage of the unit can be seen in one possible exemplification in FIGS. 1D and 1E, namely that, on the one hand, the container or the container mouth respectively is protected against dirt, and, on the other, the interior of the holding and centering puck is protected when in idling mode without containers.

FIG. 1E shows the holding device 1 from FIG. 1A-1D. The container 2, in this case a plastic beverage bottle, is introduced into the recess 6. In this situation, the mouth region 2a of the beverage bottle 2 is guided through the recess 6.

The clamping elements 8a-8c are in the clamping position, and in contact with the contact surfaces 9a-9c, beneath a flange 2b, symmetrically on the outside 2c of the container 2. Due to the pre-tension provided by the springs 21a-21c, a pressure tension is exerted onto the container 2.

Due to the uniform arrangement in the circumferential direction of the clamping elements 8a-8c, the container 2 is automatically in the central position, i.e. the container axis B and the mid-axis A of the recess 6 lie above one another.

In this exemplification (FIGS. 1A-1E), the clamping elements 8a-8c are configured as a central closure arrangement, in which the clamping element 8a-8c are pushed above one another in lamellar fashion between the release position and the closure position, in a similar manner to an iris diaphragm. No contact takes place of the contact surfaces 9a-9c of the clamping elements 8a-8c against one another. The clamping elements 8a-8c lying in sections above one another therefore form a plane aligned parallel or substantially parallel to the housing elements 4, 5. As an alternative, the clamping elements 8a-8c can also be formed as a positive-fit closure arrangement with contact surfaces 9a-9c formed corresponding to one another.

The closure unit 22 with its centering tulip 24 is introduced by sections into the container opening 23 and closes this gas-tight. By way of the gas outlet opening 26, a medium, such as a gaseous medium, can be introduced into the container 2, in this case a plastic bottle, in order to create an overpressure in the plastic bottle and achieve shape stability of the outer wall.

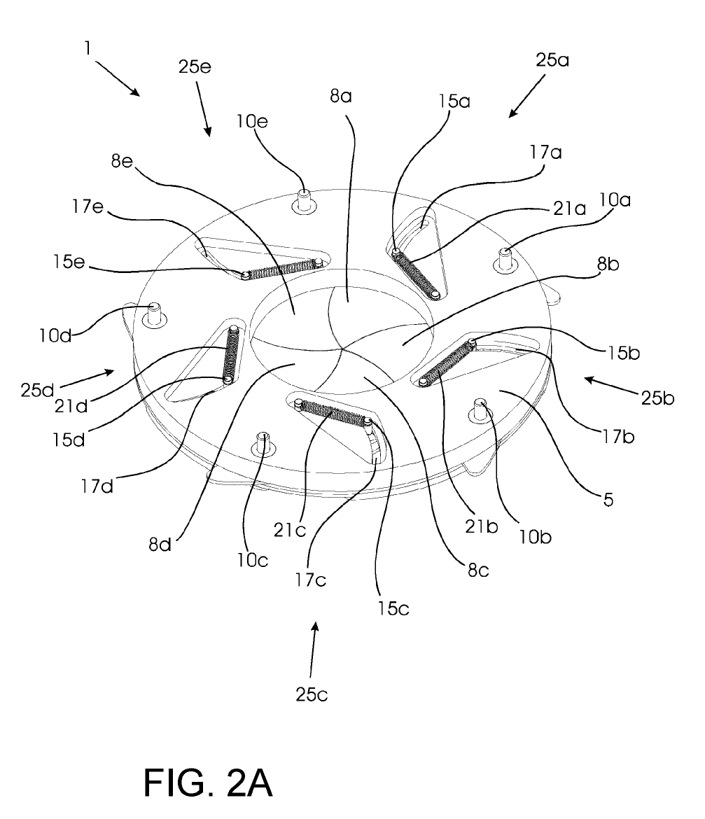

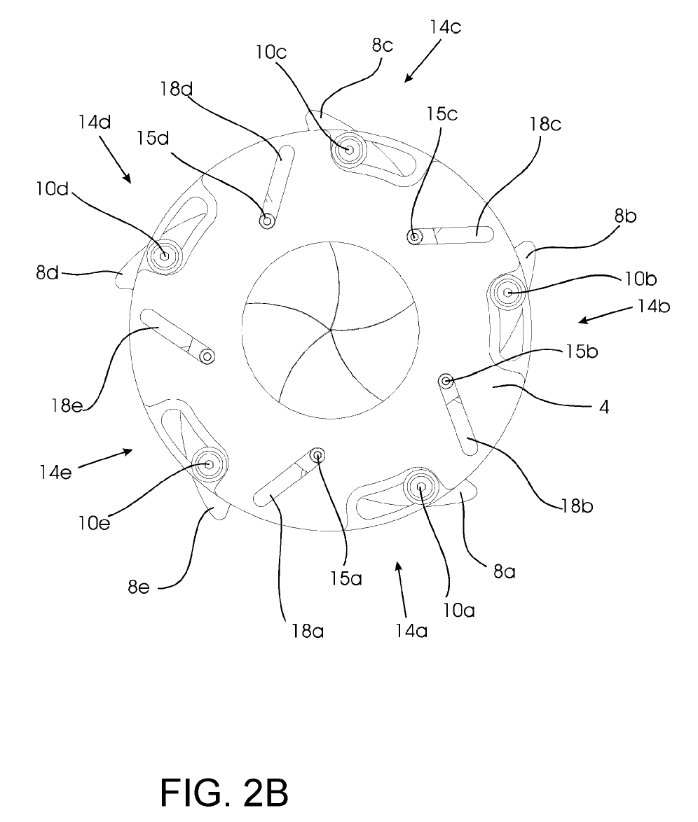

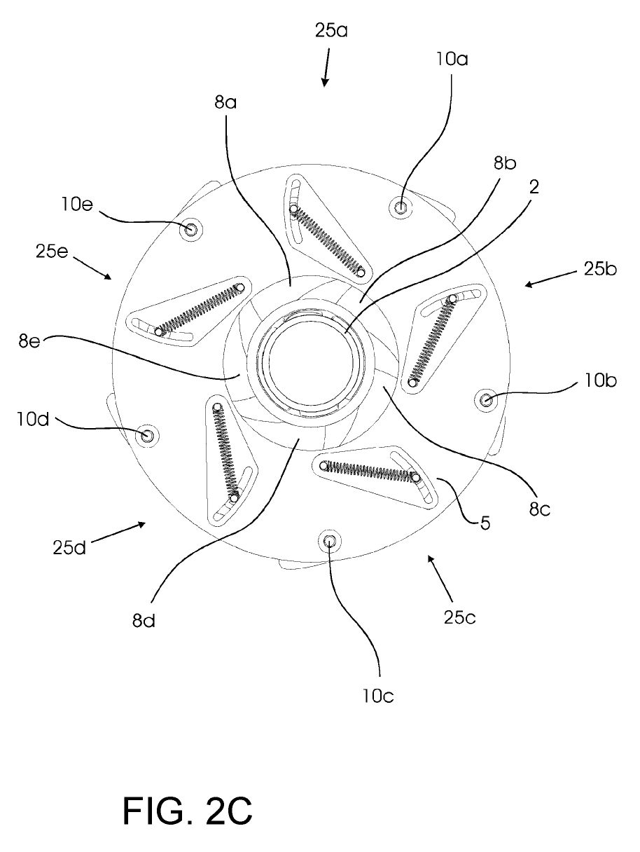

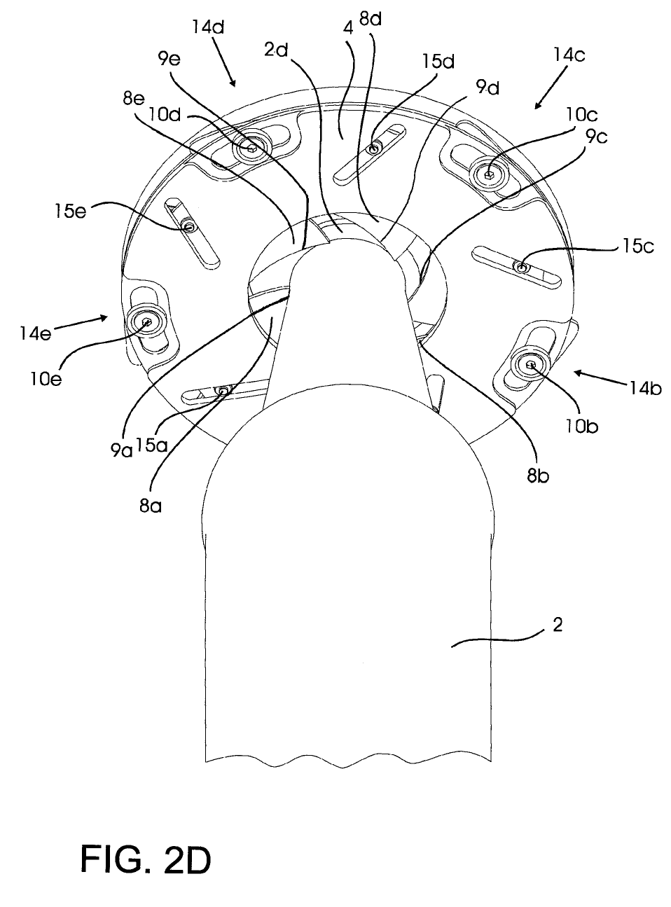

FIGS. 2A-2D show a second exemplification of the holding device 1 for containers 2, with five clamping elements 8a-8e and in each case a related rotation axle 10a-10e and guide device 25a-25e.

FIG. 2A shows the second exemplification of the holding device 1 with clamping elements 8a-8e in a closed position. The clamping elements 8a-8e are in contact with one another with their contact surfaces 9a-9e, and are fully extended into the recesses 6, such that they close them. The clamping elements 8a-8e comprise contact sections 9a-9e configured as curved, which in the closed position are in contact with one another.

Due to the springs 21a-21d which are provided, a pre-tension is imposed on the clamping elements 8a-8e, which holds them in the closed position shown.

FIG. 2B shows the holding device 1 from FIG. 2A from the underside. Arranged in the circumferential direction around the recess 6 are thrust guides 14a-14e in the form of arcs of a circle, spaced at a uniform distance from one another. Mounted in the thrust guides 14a-14e are the rotation axles 10a-10e, which can be thrust forwards and backwards. The thrust movement of the rotation axles 10a-10e is created by a rotational movement of the lower housing element 4 opposite the upper housing element 5. Represented in the lower housing element 4 are, in addition, link guides 18a-18e configured as straight, which are arranged in the housing element 5 symmetrically to one another and obliquely to the radial direction. The link guides 17a-17e in the upper housing element 4 (FIG. 2) are configured as curved and likewise arranged symmetrically to one another and obliquely to the radial direction in the housing element.

The radial movement of the clamping elements 8a-8e takes place at the rotational movement of the housing elements 4, 5, due to the link bolts 15a-15e mounted in the link guide 17a-17e, 18a-18e and connected to the clamping elements 8a-8e. The link bolts 15a-15e are displaced in the link guides 17a-17e, 18a-18e at the rotational movement.

The second exemplification differs from the first exemplification in that, instead of three clamping elements 8a-8c, five clamping elements 8a-8e are arranged, and the clamping elements 8a-8e are not configured as a central iris diaphragm closure but as a positive-fit closure, in which the clamping elements 8a-8e comprise contact surfaces 9a-9e which correspond with one another. In the closed position, the clamping elements 8a-8e are therefore not arranged above one another but abut against one another with their contact surfaces 9a-9e and thereby close the recess 6, in sections or completely.

Due to the two additional clamping elements 8d-8e, the container 2 is clamped between five contact surfaces 9a-9e, coming in contact in synchrony or substantially synchronously on the container 2, as a result of which a perceptibly more stable fixing of the container 2 in the central position is achieved. On the other hand, due to the configuration of the clamping elements 8a-8e as a positive-fit closure, each clamping element 8a-8e can be configured as perceptibly thicker and therefore more stable, without substantially changing the overall height of the holding device 1.

Corresponding to the configuration as a positive-fit closure, the clamping elements 8a-8e are in each case arranged parallel or substantially parallel to the housing elements 4, 5, while the clamping elements 8a-8c from the first exemplification (FIGS. 1A-1E) exclusively form a plane arranged parallel or substantially parallel to the housing elements 4, 5.

In principle, holding devices 1 with three clamping elements 8a-8c as positive-fit closure, and, respectively, holding devices 1 comprising five clamping elements 8a-8e can also be configured as central closures.

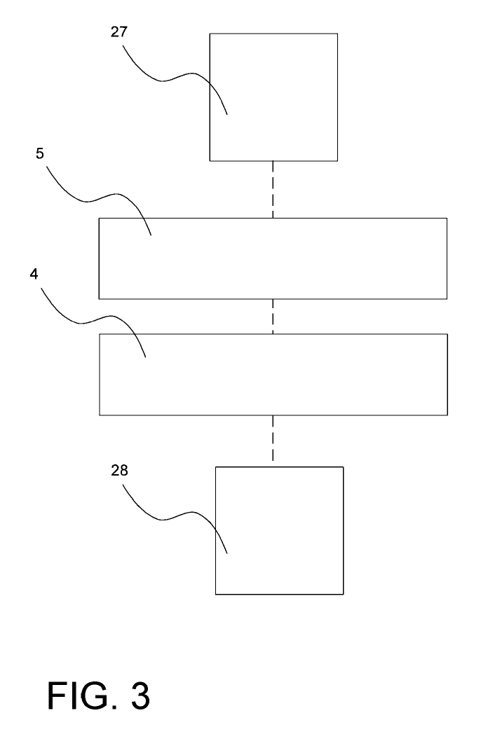

FIG. 3 is a block diagram of a possible exemplification of the holding device. The housing elements 4, 5 are represented in block form and are operatively connected to one another. As discussed herein, the two housing elements 4, 5 can be rotatable relative to one another. Of the two housing elements 4, 5, one can be stationary or fixed in position, while the other is rotatable with respect to the stationary one. Alternatively, both of the housing elements 4, 5, could be movable or rotatable. Any rotatable housing element can be operatively or directly connected to a drive or other mechanism that generates the rotational movement of the housing element. Any stationary housing element can be connected to a stationary object or mount that keeps the stationary housing element in a fixed position. In the exemplification in FIG. 3, housing element 4 is movable, while housing element 5 is stationary.

Mounting structure 27 holds housing element 5 in a fixed or stationary position, while drive device 28 imparts a rotational movement to housing element 4 to rotate housing element 4 with respect to housing element 5. In an alternative configuration, mounting structure 27 could hold housing element 4 in a stationary position, while drive device 28 could rotate housing element 5. In yet another alternative configuration, mounting structure 27 could be replaced with an additional drive device 28, such that both housing element 4 and housing element 5 could be rotated with respect to one another. The relative movement of the housing elements 4, 5 causes the movement of the clamping elements 8a-8e.

The present application relates to a holding and centering device for containers 2. The aim of the present application is to provide an improved holding and centering device which can be used for a plurality of different container types. This is achieved by providing a centering head with a recess 6 for introducing the container and a clamping device 7 arranged on the centering head 3 for clamping the container, wherein the clamping elements 8a, 8c of the clamping device are mounted in a movable manner in a radial direction between a clamping position, in which the clamping elements are extended into the recess, and a release position, in which the clamping elements are retracted.

One feature or aspect of an exemplification is believed at the time of the filing of this patent application to possibly reside broadly in a holding and centering device for containers 2, comprising a disk-shaped or ring-shaped centering head which includes a centrally arranged recess 6 for the introduction of at least one mouth region 2a of the container 2 and a clamping device 7 arranged at the centering head 3 for clamping the container 2, wherein the clamping device 7 comprises at least three clamping elements 8a-8c arranged around the recess 6, which are movably mounted in a radial direction between a clamping position, in which the clamping elements 8a-8c extend symmetrically into the recess 6, and a release position, in which the clamping elements 8a-8c are retracted, wherein the clamping elements 8a-8c are configured as a positive-fit closure or central closure arrangement.

Another feature or aspect of an exemplification is believed at the time of the filing of this patent application to possibly reside broadly in the holding and centering device, wherein the at least five clamping elements 8a-8e are arranged around the recess.

Yet another feature or aspect of an exemplification is believed at the time of the filing of this patent application to possibly reside broadly in the holding and centering device, wherein the recess 6 extends through two housing elements 4, 5 arranged parallel or substantially parallel to one another, wherein the clamping elements 8a-8e are arranged between the housing elements 4, 5.

Still another feature or aspect of an exemplification is believed at the time of the filing of this patent application to possibly reside broadly in the holding and centering device, wherein each clamping element 8a-8e is rotatably mounted about an axis of rotation 10a-10e arranged in the longitudinal direction.

A further feature or aspect of an exemplification is believed at the time of the filing of this patent application to possibly reside broadly in the holding and centering device, wherein the housing elements 4, 5 are arranged such as to rotate against one another, and the clamping elements 8a-8e can be moved between the release position and the clamping position by means of the rotation movement.

Another feature or aspect of an exemplification is believed at the time of the filing of this patent application to possibly reside broadly in the holding and centering device, wherein the rotation axle 10a-10e is mounted with a first end 11a-11e in a fixed position in one of the housing elements 4, 5 and with a second end 12a-12e is movably mounted in the other of the housing elements 4, 5.

Yet another feature or aspect of an exemplification is believed at the time of the filing of this patent application to possibly reside broadly in the holding and centering device, wherein each clamping element 7 comprises a guide device 25a-25e with a link bolt 15a-15c arranged at the clamping element 8a-8e, which is guided with a first section 16a-16c in a bolt guide 17a-17c of the first housing element 4.

Still another feature or aspect of an exemplification is believed at the time of the filing of this patent application to possibly reside broadly in the holding and centering device, wherein the link bolt 15a-15e is guided with a second section 19a-19e in a link guide 18a-18e of the second housing element 5.

A further feature or aspect of an exemplification is believed at the time of the filing of this patent application to possibly reside broadly in the holding and centering device, wherein a spring 21a-21c is arranged, which creates a pre-tension, in one possible exemplification a drawing tension, between the link bolt 15a-15c and a bearing element 20a-20c arranged at the centering head.

Another feature or aspect of an exemplification is believed at the time of the filing of this patent application to possibly reside broadly in the holding and centering device, wherein a closure unit 22 is arranged for the closing of a container opening 23.

Yet another feature or aspect of an exemplification is believed at the time of the filing of this patent application to possibly reside broadly in the holding and centering device, wherein the closure unit 22 is configured such as to introduce a medium into the container 2.

Still another feature or aspect of an exemplification is believed at the time of the filing of this patent application to possibly reside broadly in method of holding and centering beverage bottles during handling of the beverage bottles by a beverage bottle handling arrangement, said handling arrangement comprising: a plurality of handling stations to label beverage bottles or print on outer surfaces of beverage bottles; each of said handling stations comprising: a holding and centering device to hold and center a beverage bottle, and a pressurizing device to pressurize the interior of a beverage bottle; said holding and centering device comprising a centering head being ring-shaped with a central opening therein; said central opening being configured to permit insertion of a mouth portion of a beverage bottle into said centering head; a clamping device to clamp the beverage bottle; said clamping device comprising at least three essentially identical clamping elements disposed at said centering head and essentially equally spaced around said opening; said clamping elements being movable between a clamping position and a retracted position; said clamping elements being configured and disposed, upon being extended into said opening, to lie next to each other in the same plane, or to lie one on top of the other in layers; and said method comprising the steps of: moving beverage bottles into said beverage bottle handling stations; inserting mouth portions of said beverage bottles into said central openings in said centering heads; moving said clamping elements at essentially the same time and at essentially the same speed from said retracted position toward said beverage bottles; moving said clamping elements into contact with said beverage bottles at neck portions of said beverage bottles under annular flanges of said beverage bottles; clamping said beverage bottles in said clamping position by each of said clamping elements exerting essentially equal force; supporting said beverage bottles under said annular flanges with said clamping elements; pressurizing the interior of said beverage bottles with gas; labeling said beverage bottles with labels or printing on outer surfaces of said beverage bottles; and retracting said clamping elements and releasing said beverage bottles.

A further feature or aspect of an exemplification is believed at the time of the filing of this patent application to possibly reside broadly in beverage bottle handling arrangement for performing the method, said handling arrangement comprising: a plurality of handling stations to label beverage bottles or print on outer surfaces of beverage bottles; each of said handling stations comprising: a holding and centering device to hold and center a beverage bottle, and a pressurizing device to pressurize the interior of a beverage bottle; said holding and centering device comprising a centering head being ring-shaped with a central opening therein; said central opening being configured to permit insertion of a mouth portion of a beverage bottle into said centering head; a clamping device to clamp the beverage bottle; said clamping device comprising at least three essentially identical clamping elements disposed at said centering head and essentially equally spaced around said opening; said clamping elements being movable between a clamping position and a retracted position; and said clamping elements being configured and disposed, upon being extended into said opening, to lie next to each other in the same plane, or to lie one on top of the other in layers.

Another feature or aspect of an exemplification is believed at the time of the filing of this patent application to possibly reside broadly in a container handling arrangement for holding and centering containers, such as beverage bottles, said container handling arrangement comprising: a centering head being disk-shaped or ring-shaped with a central opening therein; said central opening being configured to permit insertion of a mouth portion of a container into said centering head; a clamping device being configured to clamp the container; said clamping device comprising at least three clamping elements disposed at said centering head and essentially equally spaced around said opening; said clamping elements being movable between a clamping position and a retracted position; and said clamping elements being configured and disposed, upon being in said clamping position, to lie next to each other in the same plane, or to lie one on top of the other in layers.

Still another feature or aspect of an exemplification is believed at the time of the filing of this patent application to possibly reside broadly in the container handling arrangement, wherein said clamping device comprises at least five clamping elements.

Yet another feature or aspect of an exemplification is believed at the time of the filing of this patent application to possibly reside broadly in the container handling arrangement, wherein: said centering head comprises a first head part and a second head part, each being similarly disk-shaped or ring-shaped with an opening therein; said opening in said first head part is aligned with said opening in said second head part to form said central opening of said centering head; and said clamping elements are disposed between said first and second head parts of said centering head.

A further feature or aspect of an exemplification is believed at the time of the filing of this patent application to possibly reside broadly in the container handling arrangement, wherein each clamping element is rotatably mounted about a rotation axle that is substantially perpendicular to said centering head.

Another feature or aspect of an exemplification is believed at the time of the filing of this patent application to possibly reside broadly in the container handling arrangement, wherein: said first head part and said second head part are rotatable with respect to one another; and said clamping elements are movable between said retracted position and said clamping position upon rotation of one or both of said first head part and said second head part.

Yet another feature or aspect of an exemplification is believed at the time of the filing of this patent application to possibly reside broadly in the container handling arrangement, wherein each of said rotation axles comprises: a first end mounted in a fixed position in said first head part; and a second end movably mounted in said second head part.

Still another feature or aspect of an exemplification is believed at the time of the filing of this patent application to possibly reside broadly in the container handling arrangement, wherein: said first head part comprises a plurality of bolt guides; each of said clamping elements comprises a link bolt; and each of said link bolts comprises a first portion disposed to project into and be guided by a corresponding one of said bolt guides.

A further feature or aspect of an exemplification is believed at the time of the filing of this patent application to possibly reside broadly in the container handling arrangement, wherein: said second head part comprises a plurality of link guides; and each of said link bolts comprises a second portion disposed to project into and be guided by a corresponding one of said link guides.

Another feature or aspect of an exemplification is believed at the time of the filing of this patent application to possibly reside broadly in the container handling arrangement, wherein: said centering head comprises springs and bearing elements; each of said springs connects each link bolt to a corresponding one of said bearing elements; and said springs generate a pre-tension or drawing tension between said link bolts and said bearing elements.

Still another feature or aspect of an exemplification is believed at the time of the filing of this patent application to possibly reside broadly in the container handling arrangement, further comprising closure units to close mouth openings of containers.

Yet another feature or aspect of an exemplification is believed at the time of the filing of this patent application to possibly reside broadly in the container handling arrangement, wherein said closure units are configured to introduce a medium into containers.

A further feature or aspect of an exemplification is believed at the time of the filing of this patent application to possibly reside broadly in the container handling arrangement, wherein: said clamping position is the position in which each of said clamping elements projects into said opening an essentially equivalent distance sufficient to clamp the container between said clamping elements; and said retracted position is the position in which said clamping elements are disposed away from a central portion of said opening a sufficient distance to permit insertion of the mouth portion of a container between said clamping elements.

Another feature or aspect of an exemplification is believed at the time of the filing of this patent application to possibly reside broadly in the container handling arrangement, wherein: said centering head comprises a first head part and a second head part, each being similarly disk-shaped or ring-shaped with an opening therein; said opening in said first head part is aligned with said opening in said second head part to form said central opening of said centering head; said clamping elements are disposed between said first and second head parts of said centering head; each clamping element is rotatably mounted about a rotation axle that is substantially perpendicular to said centering head; and each of said rotation axles comprises: a first end mounted in a fixed position in said first head part; and a second end movably mounted in said second head part.

Still another feature or aspect of an exemplification is believed at the time of the filing of this patent application to possibly reside broadly in a method of handling containers, such as beverage bottles, with a container handling arrangement, said handling arrangement comprising: a centering head being disk-shaped or ring-shaped with a central opening therein; said central opening being configured to permit insertion of a mouth portion of a container into said centering head; a clamping device being configured to clamp the container; said clamping device comprising at least three clamping elements disposed at said centering head and essentially equally spaced around said opening; said clamping elements being movable between a clamping position and a retracted position; said clamping elements being configured and disposed, upon being in said clamping position, to lie next to each other in the same plane, or to lie one on top of the other in layers; and said method comprising the steps of: inserting mouth portions of containers into said central openings in said centering heads; moving said clamping elements from said retracted position toward and into contact with neck portions of said containers; clamping said containers in said clamping position; and retracting said clamping elements and releasing said containers.

Yet another feature or aspect of an exemplification is believed at the time of the filing of this patent application to possibly reside broadly in the method, wherein: said container handling arrangement comprises closure units to close mouth openings of containers; said closure units are configured to introduce a pressure medium into containers to pressurize the containers; said containers comprise beverage bottles; and said method further comprises: closing mouth openings of said beverage bottles with said closure units; introducing a pressure medium into said beverage bottles via said closure units; and pressurizing said beverage bottles to reinforce the walls of said beverage bottles during labeling or printing of said beverage bottles.

A further feature or aspect of an exemplification is believed at the time of the filing of this patent application to possibly reside broadly in the method, wherein said method further comprises moving said clamping elements toward one another when a container is not being handled until said clamping elements completely cover said central opening to protect said closure units from contamination by contaminants passing through said central opening.

Another feature or aspect of an exemplification is believed at the time of the filing of this patent application to possibly reside broadly in the method, wherein said method further comprises: moving said clamping elements at essentially the same time and at essentially the same speed from said retracted position toward said containers; and clamping said containers in said clamping position by each of said clamping elements exerting essentially equal force.

Still another feature or aspect of an exemplification is believed at the time of the filing of this patent application to possibly reside broadly in the method, wherein containers comprise beverage bottles with annular flanges about the necks thereof, and said method further comprises moving said clamping elements into contact with said beverage bottles at neck portions of said beverage bottles under said annular flanges.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

The following patents, patent applications, patent publications, and patent documents are hereby incorporated by reference as if set forth in their entirety herein except for the exceptions indicated herein, as follows: WO2005007556 A1, having the title “A CAPPING UNIT FOR CLOSING CONTAINERS WITH RESPECTIVE CAPS”, published on Jan. 27, 2005; DE 10 2009 005 181 A1, having the title “CONTAINER TREATMENT MACHINE”, published on Jul. 29, 2010, and DE 10 2011 112 106 B3, having the title “Apparatus for performing multi-color printing on packaging structure e.g. bottle, has holding and centering unit which holds packaging structure, and specific unit of pressure segment supports and releases holding and centering unit”, published on Feb. 21, 2013.

All of the patents, patent applications, patent publications, and other documents, except for the exceptions indicated herein, which were cited in the German Office Action dated Apr. 11, 2015, and/or cited elsewhere, as well as the German Office Action document itself, are hereby incorporated by reference as if set forth in their entirety herein except for the exceptions indicated herein, as follows: CH 136 882 A, having the title “Vorrichtung zum Erzeugen von kreisformigen Schnitten in Büchsendeckelflächen”, published on Dec. 15, 1929; WO 2011/121624 A1, having the title “GRIPPING DEVICE FOR CONTAINERS”, published on Oct. 6, 2011; U.S. Pat. No. 5,160,110, having the title “Christmas tree stand”, published on Nov. 3, 1992; and U.S. Pat. No. 4,721,138, having the title “Continuously rotating filling device with bottle control means”, published on Jan. 26, 1988.

All of the patents, patent applications, patent publications, and other documents, except for the exceptions indicated herein, which were cited in the International Search Report dated Oct. 5, 2015, and/or cited elsewhere, as well as the International Search Report document itself, are hereby incorporated by reference as if set forth in their entirety herein except for the exceptions indicated herein, as follows: FR 2 507 520 A1, having the title “GRIPPER FOR A LIFTING OR CONVEYING APPLIANCE”, published on Dec. 17, 1982; EP 0 293 344 A1, having the title “Handling device for tires to be remolded on vulcanization presses, with selection from different stocks of tires”, published on Nov. 30, 1988; DE 14 82 616 A1, having the title “Vorrichtung zum mittigen Festhalten von Flaschen verschiedenen Durchmessers in Fuell-, Verschliess- and dergleichen Maschinen”, published on Jan. 9, 1969; and U.S. Pat. No. 4,121,868, having the title “Cam actuated pivotal jaw gripping apparatus”, published on Oct. 24, 1978.

The corresponding foreign and international patent publication applications, namely, Federal Republic of Germany Patent Application No. 10 2014 111 493.0, filed on Aug. 12, 2014, having inventor Holger STENNER, and DE-OS 10 2014 111 493.0 and DE-PS 10 2014 111 493.0, and International Application No. PCT/EP2015/065022, filed on Jul. 1, 2015, having WIPO Publication No. WO 2016/023674 and inventor Holger STENNER, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2015/065022 and German Patent Application 10 2014 111 493.0, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2015/065022 and DE 10 2014 111 493.0 from which this patent application claims priority which do not have to do with the correction of the translation in this patent application are not to be included in this patent application in the incorporation by reference.

Any statements about admissions of prior art in the original foreign patent applications PCT/EP2015/065022 and DE 10 2014 111 493.0 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

### AT LEAST PARTIAL NOMENCLATURE

1 Holding and centering device
2 Container
2a Mouth region
2b Flange
2c Outside of container
3 Centering head
4 First housing element
5 Second housing element
6 Recess
7 Clamping device
8a-8e Clamping elements
9a-9e Contact surfaces of clamping elements
313 10a-10e Rotation axle
11a-11e First end of rotation axle
12a-12e Second end of rotation axle
14a-14e Thrust guide
15a-15e Link bolt
16a-16e First section of link bolt
17a-17e Link guide
18a-18e Link guide, lower part
19a-19e Second section of link bolt
20a-20e Bearing element
21a-21e Spring
22 Closure unit
23 Container opening
24 Centering tulip
25a-25e Guide device
26 Gas outlet opening

What is claimed is:

1. A method of holding and centering beverage bottles during handling of the beverage bottles by a beverage bottle handling arrangement, said handling arrangement comprising:
a plurality of handling stations to label beverage bottles or print on outer surfaces of beverage bottles;
each of said handling stations comprising: a holding and centering device to hold and center a beverage bottle, and a pressurizing device to pressurize the interior of a beverage bottle;
said holding and centering device comprising a centering head being ring-shaped with a central opening therein;
said central opening being configured to permit insertion of a mouth portion of a beverage bottle into said centering head;
a clamping device to clamp the beverage bottle;
said clamping device comprising at least three essentially identical clamping elements disposed at said centering head and essentially equally spaced around said opening;
said clamping elements being movable between a clamping position and a retracted position;
said clamping elements being configured and disposed, upon being extended into said opening, to lie next to each other in the same plane, or to lie one on top of the other in layers; and
said method comprising the steps of:
moving beverage bottles into said beverage bottle handling stations;
inserting mouth portions of said beverage bottles into said central openings in said centering heads;
moving said clamping elements at essentially the same time and at essentially the same speed from said retracted position toward said beverage bottles;
moving said clamping elements into contact with said beverage bottles at neck portions of said beverage bottles under annular flanges of said beverage bottles;
clamping said beverage bottles in said clamping position by each of said clamping elements exerting essentially equal force;
supporting said beverage bottles under said annular flanges with said clamping elements;
pressurizing the interior of said beverage bottles with gas;
labeling said beverage bottles with labels or printing on outer surfaces of said beverage bottles; and
retracting said clamping elements and releasing said beverage bottles.

2. A beverage bottle handling arrangement for performing the method according to claim 1, said handling arrangement comprising:
a plurality of handling stations to label beverage bottles or print on outer surfaces of beverage bottles;
each of said handling stations comprising: a holding and centering device to hold and center a beverage bottle, and a pressurizing device to pressurize the interior of a beverage bottle;
said holding and centering device comprising a centering head being ring-shaped with a central opening therein;
said central opening being configured to permit insertion of a mouth portion of a beverage bottle into said centering head;
a clamping device to clamp the beverage bottle;
said clamping device comprising at least three essentially identical clamping elements disposed at said centering head and essentially equally spaced around said opening;
said clamping elements being movable between a clamping position and a retracted position; and
said clamping elements being configured and disposed, upon being extended into said opening, to lie next to each other in the same plane, or to lie one on top of the other in layers.

3. A container handling arrangement for holding and centering containers, such as beverage bottles, said container handling arrangement comprising:
a centering head being disk-shaped or ring-shaped with a central opening therein;
said central opening being configured to permit insertion of a mouth portion of a container into said centering head;
a clamping device being configured to clamp the container;
said clamping device comprising at least three clamping elements disposed at said centering head and essentially equally spaced around said opening;
said clamping elements being movable between a clamping position and a retracted position; and
said clamping elements being configured and disposed, upon being in said clamping position, to lie next to each other in the same plane, or to lie one on top of the other in layers.

4. The container handling arrangement according to claim 3, wherein said clamping device comprises at least five clamping elements.

5. The container handling arrangement according to claim 4, wherein:
said centering head comprises a first head part and a second head part, each being similarly disk-shaped or ring-shaped with an opening therein;
said opening in said first head part is aligned with said opening in said second head part to form said central opening of said centering head; and
said clamping elements are disposed between said first and second head parts of said centering head.

6. The container handling arrangement according to claim 5, wherein each clamping element is rotatably mounted about a rotation axle that is substantially perpendicular to said centering head.

7. The container handling arrangement according to claim 6, wherein:
said first head part and said second head part are rotatable with respect to one another; and
said clamping elements are movable between said retracted position and said clamping position upon rotation of one or both of said first head part and said second head part.

8. The container handling arrangement according to claim 7, wherein each of said rotation axles comprises:
a first end mounted in a fixed position in said first head part; and
a second end movably mounted in said second head part.

9. The container handling arrangement according to claim 8, wherein:
said first head part comprises a plurality of bolt guides;
each of said clamping elements comprises a link bolt; and
each of said link bolts comprises a first portion disposed to project into and be guided by a corresponding one of said bolt guides.

10. The container handling arrangement according to claim 9, wherein:
said second head part comprises a plurality of link guides; and
each of said link bolts comprises a second portion disposed to project into and be guided by a corresponding one of said link guides.

11. The container handling arrangement according to claim 10, wherein:
said centering head comprises springs and bearing elements;
each of said springs connects each link bolt to a corresponding one of said bearing elements; and
said springs generate a pre-tension or drawing tension between said link bolts and said bearing elements.

12. The container handling arrangement according to claim 11, further comprising closure units to close mouth openings of containers.

13. The container handling arrangement according to claim 12, wherein said closure units are configured to introduce a medium into containers.

14. The container handling arrangement according to claim 3, wherein:
said clamping position is the position in which each of said clamping elements projects into said opening an essentially equivalent distance sufficient to clamp the container between said clamping elements; and
said retracted position is the position in which said clamping elements are disposed away from a central portion of said opening a sufficient distance to permit insertion of the mouth portion of a container between said clamping elements.

15. The container handling arrangement according to claim 3, wherein:
said centering head comprises a first head part and a second head part, each being similarly disk-shaped or ring-shaped with an opening therein;
said opening in said first head part is aligned with said opening in said second head part to form said central opening of said centering head;
said clamping elements are disposed between said first and second head parts of said centering head;
each clamping element is rotatably mounted about a rotation axle that is substantially perpendicular to said centering head; and
each of said rotation axles comprises:
a first end mounted in a fixed position in said first head part; and
a second end movably mounted in said second head part.

16. A method of handling containers, such as beverage bottles, with a container handling arrangement, said handling arrangement comprising:
a centering head being disk-shaped or ring-shaped with a central opening therein;
said central opening being configured to permit insertion of a mouth portion of a container into said centering head;
a clamping device being configured to clamp the container;
said clamping device comprising at least three clamping elements disposed at said centering head and essentially equally spaced around said opening;
said clamping elements being movable between a clamping position and a retracted position;
said clamping elements being configured and disposed, upon being in said clamping position, to lie next to each other in the same plane, or to lie one on top of the other in layers; and
said method comprising the steps of:
inserting mouth portions of containers into said central openings in said centering heads;
moving said clamping elements from said retracted position toward and into contact with neck portions of said containers;
clamping said containers in said clamping position; and
retracting said clamping elements and releasing said containers.

17. The method according to claim 16, wherein:
said container handling arrangement comprises closure units to close mouth openings of containers;
said closure units are configured to introduce a pressure medium into containers to pressurize the containers;
said containers comprise beverage bottles; and
said method further comprises:
closing mouth openings of said beverage bottles with said closure units;
introducing a pressure medium into said beverage bottles via said closure units; and
pressurizing said beverage bottles to reinforce the walls of said beverage bottles during labeling or printing of said beverage bottles.

18. The method according to claim 17, wherein said method further comprises moving said clamping elements toward one another when a container is not being handled until said clamping elements completely cover said central opening to protect said closure units from contamination by contaminants passing through said central opening.

19. The method according to claim 16, wherein said method further comprises:
moving said clamping elements at essentially the same time and at essentially the same speed from said retracted position toward said containers; and
clamping said containers in said clamping position by each of said clamping elements exerting essentially equal force.

20. The method according to claim 19, wherein containers comprise beverage bottles with annular flanges about the necks thereof, and said method further comprises moving said clamping elements into contact with said beverage bottles at neck portions of said beverage bottles under said annular flanges.
